(19) United States
(12) Patent Application Publication
(10) Pub. No.: US 2023/0365145 A1
(43) Pub. Date: Nov. 16, 2023

(54) METHOD, SYSTEM AND COMPUTER PROGRAM PRODUCT FOR CALIBRATING AND VALIDATING A DRIVER ASSISTANCE SYSTEM (ADAS) AND/OR AN AUTOMATED DRIVING SYSTEM (ADS)

(71) Applicant: Dr. Ing. h.c. F. Porsche Aktiengesellschaft, Stuttgart (DE)

(72) Inventor: Moritz Markofsky, Renningen (DE)

(21) Appl. No.: 18/132,476

(22) Filed: Apr. 10, 2023

(30) Foreign Application Priority Data
May 13, 2022 (DE) 10 2022 112 059.7

(51) Int. Cl. B60W 50/06; B60W 50/00; G06F 30/27

(52) U.S. Cl. CPC B60W 50/06; B60W 50/0098; G06F 30/27; B60W 2050/0052; B60W 2050/0026; B60W 2520/105; B60W 2520/10; B60W 2520/06; B60W 2554/20; B60W 2554/40; B60W 2552/05; B60W 2555/20; B60W 2555/60; B60W 2554/406

(57) ABSTRACT

A method calibrates and validates a driver assistance system (ADAS) and/or an automated driving system (ADS) for a driving task in at least one scenario. The scenario represents a traffic event in a time sequence and is defined by selected parameters and associated parameter values. The method includes: creating first test cases by selecting scenarios, scenario parameters and calibration parameters using a test strategy for the driving task. The method proceeds by performing a simulation to determine simulation results; evaluating of the simulation results; adapting the test strategy to the evaluation results; creating second test cases using the adapted test strategy; starting a new simulation cycle; repeating the adaptation of the test strategy if an evaluation criterion is not met; or passing on the test cases of the last simulation cycle to an output module; outputting results of the test cases from the output module for calibration and validation.

### CROSS-REFERENCE TO RELATED APPLICATION

This application claims priority on German Patent Application No 10 2022 112 059.7 filed May 13, 2022, the entire disclosure of which is incorporated herein by reference.

### BACKGROUND

### Field of the Invention

The invention relates to a method, system and computer program product for calibrating and validating a driver assistance system (ADAS) and/or an automated driving system (ADS) and/or a driving function.

### Related Art

Vehicles are known to include a variety of driving assistance systems or automated driving assistance functions to assist the driver in driving and to increase safety. For example, driving assistance systems support speed and distance control, as well as lane keeping and lane changing functions. For example, a certain maximum speed can be set and cannot be exceeded as long as the speed limiting function is enabled. Radar sensors and camera systems also are used to monitor and/or maintain a certain distance from a vehicle ahead or from a vehicle in a side region. This leads to improved driving convenience and safety when driving on a highway and during overtaking maneuvers.

This trend towards driver assistance systems (Advanced Driver Assistance System (ADAS)), and automated driving systems (ADS) for motor vehicles, aircraft and marine vehicles require extensive safeguarding strategies, since the responsibility for vehicle management is no longer entirely with the driver. Rather, active functions are taken over by computer units in the vehicle. Thus, autonomously moving objects must have a very low error rate in their driving behavior. Detection and classification of objects and the interpretation of traffic scenarios in the vicinity of a vehicle are important prerequisites for a safe functional capability of ADAS/ADS. For this purpose, the targeted testing and training of the driver assistance systems and automated driving systems with both extreme and exceptional situations (corner cases) and also with day-to-day situations are required. Such extreme situations result from a particular combination of different factors. Examples include infrastructural particularities, such as, the type of road, the edge construction on a road, the quality of the markings and ambient conditions such as weather, the time of day and the time of year. Furthermore, the behavior of the other road users, the geographic topography and weather conditions play a major role.

As ADAS/ADS performance increases, so do the number of driving scenarios that the systems must address in traffic. Therefore, to ensure a safe, convenient and efficient behavior of ADAS/ADS, individual functions and the overall system undergo a calibration and validation process during vehicle development.

However, calibration and validation also present major challenges in the integration of modern ADAS/ADS into a vehicle due to a functional specification deficit in driving assistance systems. A requirement-based test process has been established in the automotive industry for conventional systems, in which test cases are implemented based on test specifications. However, this requirement-based test process currently is lacking for ADAS/ADS, because, in contrast to conventional systems, a significantly greater number of influencing variables are to be considered, such as the driving environment that is detected by sensors. The number of scenarios that can occur in the driving environment of the vehicle and that need to be detected correctly and processed by ADAS/ADS is represented by an operational design domain (ODD). This includes both everyday driving scenarios and also very rarely occurring corner cases. To test, calibrate, and validate an ADAS/ADS using conventional methods, the entire ODD for an ADAS/ADS would need to be captured and documented in a catalog of requirements. This is not possible due to the complexity of the driving environment and the resulting large number of driving scenarios. This problem is referred to as a functional specification deficit. It complicates both the calibration and validation processes of ADAS/ADS and requires alternative approaches to the existing methods.

Due to the challenges in calibration and validation of ADAS/ADS, new approaches are therefore needed to carry out the vehicle development process with justifiable effort and costs. It is therefore desirable to use virtual methods to simulate calibration and validation of ADAS/ADS and to design these virtual simulation methods in a manner that enables objective comparability of various ADAS/ADS systems with differing functionalities in terms of performance and safety. The challenges arise due to the variety of scenarios, the simulation methods used and the selection of appropriate metrics to evaluate the simulation results.

WO 2021/245200 A1 discloses a scenario-based simulation of ADAS/ADS where the simulation is based on a modular architecture comprising separable sensing, predicting, planning, and control systems with partially modular subsystems.

US 2019/0235521 A1 discloses a method for evaluating control characteristics of an autonomous vehicle for development or validation purposes. The system comprises a detection and perception module as well as a planning and behavior module, each of which accesses a database.

WO 2021/245201 A1 discloses a method for evaluating the performance of a scenario-based simulation of ADAS/ADS. The simulation is based on an architecture with acquisition, projection, planning and control systems.

US 2007/0236502 A1 discloses a system for real-time visualization of a simulation. The system comprises real-time visualization software having a modular framework.

The object of the invention is to provide capabilities for virtual calibration and validation of a driver assistance system (ADAS) and/or an automated driving system (ADS) so that the calibration and validation process requires less time and can be performed with improved efficiency to enhance the safety of ADAS/ADS and to save resources and costs.

### SUMMARY

The invention allows for a selection of specific traffic scenarios suitable for calibration and validation purposes for a particular driving task and that provide a high degree of relevance for estimating the safety and functionality of a driving assistance system and/or automated driving system.

According to a first aspect, the invention provides a method for calibrating and validating a driver assistance system (ADAS) and/or an automated driving system (ADS) and/or a driving function for a set driving tasks in at least one scenario. A scenario represents a traffic event in a time sequence and is defined by a selection of parameters and associated parameter values. In a parameterized scenario, the parameters and associated parameter values are freely selectable, and in a specific scenario the scenario parameters and associated scenario parameter values are set. The method comprises the following steps:
creating first test cases by a test agent by selecting parameterized scenarios and scenario parameters as well as calibration parameters using a test strategy for the driving task;
   passing on the selected first test cases to a simulation module;
   performing a simulation by the simulation module to determine simulation results;
   passing on the simulation results to an evaluation module;
   performing an evaluation of the simulation results by the evaluating module to determine evaluation results;
   adapting the test strategy to the simulation results and the evaluation results;
   creating second test cases by the test agent using the adapted test strategy;
   starting a new simulation cycle for the second test cases;
   repeating the adaptation of the test strategy for performing a further simulation cycle if a particular evaluation criterion is not met; or
   passing on the test cases of the last simulation cycle to an output module when a particular assessment criterion is met;
   generating and outputting output results from the test cases for calibration and validation purposes from the output module, particularly in the form of calibration parameters for the driver assistance system (ADAS) and/or the automated driving system (ADS) and/or the driving function for performing the set driving task.

In some embodiments, the simulation module comprises interchangeable sub-modules. A first sub-module is configured as an environmental model module, a second sub-module is configured as a driver model module, and a third sub-module is configured as a vehicle model module.

In one embodiment, the simulation module and/or the sub-modules are connected to sensors and/or a database to obtain further information for the creation of simulation models. The simulation models are passed to a driving function module to perform the simulation of a driving assistance function of an ADAS/ADS.

In a further embodiment, the evaluation module comprises a driving function evaluation module for determining the performance and safety of a driving function using performance indicators (KPIs) and a simulation evaluation module for determining the quality of the simulation using simulation quality criteria (SQCs), and wherein the evaluation results comprise the performance indicators (KPIs) and the simulation quality criteria (SQCs).

The test cases are stored in a test database, the calibration parameters in a calibration parameter database, the parameterized scenarios and the scenario parameters in a scenario database and the evaluation results in an evaluation database.

The test strategy and/or the test agent utilizes/utilize at least one software application having calculation methods and/or algorithms of artificial intelligence.

The algorithms and calculation methods are configured as mean values, minimum and maximum values, lookup tables, expected value models, linear regression methods, Gaussian processes, fast Fourier transforms, integral and differential calculations, Markov methods, probability methods such as Monte Carlo methods, temporal difference learning, extended Kalman filters, radial basis functions, data fields, convergent neural networks, deep neural networks, and/or recurrent neural networks.

A parameter provides a physical variable, a chemical variable, a torque, a rotary speed, a voltage, a current strength, an acceleration, a speed, a braking value, a direction, an angle, a radius, a location, a number, a movable object, such as a motor vehicle, a person or a cyclist, a stationary object such as a building or tree, a road configuration such as a highway, a road sign, a traffic light, a tunnel, a roundabout, a turn-off lane, a traffic volume, a topographical structure such as an incline, a time, a temperature, a precipitation value, a weather condition and/or a time of year.

In another embodiment, the sensors are configured as radar systems, LIDAR optical distance and speed measuring systems, 2D/3D image recording cameras in the visible, IR and/or UV range, GPS systems, accelerometers, speed sensors, capacitive sensors, inductive sensors, voltage sensors, torque sensors, precipitation sensors, and/or temperature sensors.

According to a second aspect, the invention provides a system for calibrating and validating a driver assistance system (ADAS) and/or an automated driving system (ADS) and/or a driving function for a set driving task in at least one scenario. A scenario represents a traffic event in a time sequence and is defined by a selection of parameters and associated parameter values. In a parameterized scenario, the parameters and associated parameter values are freely selectable, and in a specific scenario the scenario parameters and associated scenario parameter values are set. The system comprises a test module having a test agent and a test strategy, a simulation module, an evaluation module, and an output module. The test agent is configured to create first test cases by selecting parameterized scenarios and scenario parameters as well as calibration parameters using the test strategy for the driving task and to pass on the selected first test cases to the simulation module. The simulation module is configured to perform a simulation to determine simulation results and pass on the simulation results to the evaluation module. The evaluation module is configured to perform an evaluation of the simulation results to determine evaluation results. The test module is configured to adapt the test strategy to the simulation results and the evaluation results, to create second test cases from the test agent using the adapted test strategy and to begin a new simulation cycle for the second test cases, and to repeat the adaptation of the test strategy for performing a further simulation cycle if a particular evaluation criterion is not met, or to pass on the test cases of the at least last simulation cycle to the output module when a particular evaluation criterion is met. The output module is configured to generate and to output results outputted from the test cases of the at least last simulation cycle for calibration and validation purposes, particularly in the form of calibration parameters for the driver assistance system (ADAS) and/or the automated driving system (ADS) and/or the driving function for performing the set driving task.

In a further development, the simulation module has interchangeable sub-modules, namely, a first sub-module configured as an environmental model module, a second sub-module configured as a driver model module, and a third sub-module configured as a vehicle model module.

The simulation module and/or the sub-modules may be connected to sensors and/or a database to obtain further information for the creation of simulation models. The simulation models are passed on to a driving function module for performing the simulation of a driving assistance function.

In a further embodiment, the evaluation module comprises a driving function evaluation module for determining the performance and safety of a driving function using performance indicators (KPIs) and a simulation evaluation module for determining the quality of the simulation using simulation quality criteria (SQCs). The evaluation results comprise the performance indicators (KPIs) and the simulation quality criteria (SQCs).

In some embodiments, the test cases are stored in a test database, the calibration parameters are stored in a calibration parameter database, the parameterized scenarios and the scenario parameters are stored in a scenario database, and the evaluation results are stored in an evaluation database.

The textual strategy and/or the test agent may use at least one software application having calculation methods and/or algorithms of artificial intelligence.

According to a third aspect, the invention relates to a computer program product comprising an executable program code configured to carry out the method according to the first aspect when it is executed.

The invention is explained in further detail below on the basis of embodiment examples shown in the drawings.

### BRIEF DESCRIPTION OF THE DRAWINGS

FIG. 1 is a block diagram to explain an embodiment of a system according to the invention.

FIG. 2 is a schematic representation of a graphic.

FIG. 3 is a flow diagram to explain the individual method steps of a method according to the invention.

FIG. 4 is a block diagram of a computer program product according to an embodiment of the third aspect of the invention.

### DETAILED DESCRIPTION

Additional features, aspects, and advantages of the invention or its embodiments will be explained in the following detailed description in conjunction with the claims.

Increasingly simulated traffic scenarios created by programming are used for testing, training, and securing driver assistance systems (ADAS) and automated driving systems (ADS). A scenario in the context of this description is defined as a traffic event in a temporal sequence. An example of a scenario is driving on a highway bridge, turning off on a turn-off lane, passing through a tunnel, turning onto a roundabout, or stopping in front of a pedestrian crossing. Moreover, specific visibility conditions, for example due to twilight or bright sunlight, as well as environmental conditions such as the weather and the time of year, traffic levels, and certain geographic topographical conditions, can affect a scenario. For example, an overtaking maneuver can be described as a scenario in which a first vehicle is initially behind another vehicle, then makes a lane change to the other roadway, and increases speed to overtake the other vehicle. Such a scenario is also referred to as a cut-in scenario. In addition, the time of year and weather play a role, as with heavy rain and ice, the road conditions look different than on a sunny summer day.

To use driver assistance systems (ADAS) and automated driving systems (ADS) in a motor vehicle, they must be calibrated and validated for reliable use. The calibration adapts the functions to the vehicle type as well as to the desired behavior of a driving function without changing the software code. For this purpose, the calibration parameters are modified and made available to the ADAS/ADS in a dataset. It is necessary to find a suitable dataset of calibration parameters for optimum behavior in as many operational design domain (ODD) scenarios as possible.

The goal of the validation is to comprehensively test the dataset obtained during the calibration, to demonstrate the reliability and robustness of a driver assistance system (ADAS) and/or an automated driving system (ADS) throughout the ODD, and then to release it.

According to the present invention, a modular simulation approach is used for the virtual calibration and validation of ADAS/ADS, and can be adapted fora variety of configurations of ADAS/ADS.

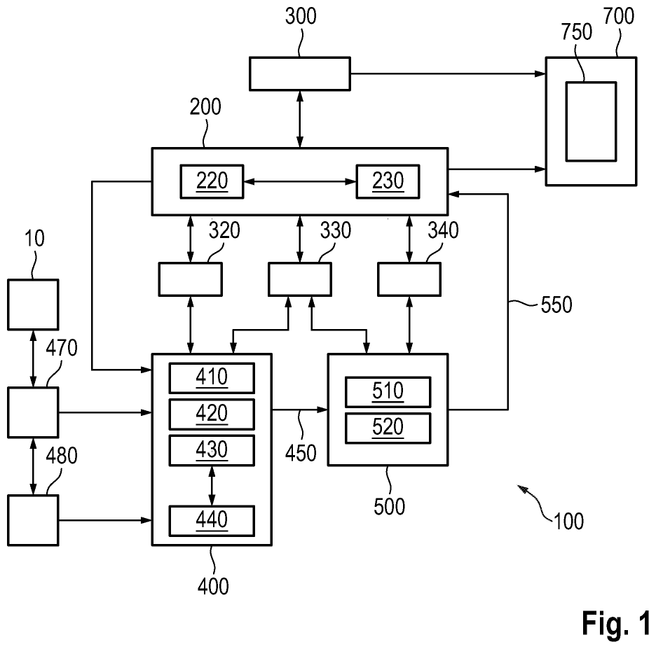

FIG. 1 shows a system 100 according to the invention for simulated calibration and validation of a driver assistance system (ADAS) and/or an automated driving system (ADS). The system 100 according to the invention comprises a test agent module 200 having a test agent 220 and a test strategy 230, a calibration parameter database 320, a scenario database 330, an evaluation database 340, a test database 300, a simulation module 400, an evaluation module 500, and an output module 700, which can each be provided with a processor and/or a memory unit.

A “module” can be understood in connection with the invention to mean a processor and/or a processor unit and/or a memory unit for storing program instructions. The processor is specifically configured to execute the program instructions to implement or realize the method according to the invention or a step of the method according to the invention. In particular, a module can be integrated into a cloud computing infrastructure.

A “processor” can be understood in connection with the invention to mean a machine or an electronic circuit. In particular, a processor can be a main processor (central processing unit (CPU)), a microprocessor, or a microcontroller, for example an application-specific integrated circuit or a digital signal processor, possibly in combination with a memory unit for storing program instructions, etc. A processor can also be understood to mean a virtualized processor, a virtual machine, or a soft CPU. For example, it can also be a programmable processor equipped with configuration steps for carrying out the above-mentioned method according to the invention or configured with configuration steps in such a way that the programmable processor realizes the features according to the invention of the method, the system, the modules, or other aspects and/or partial aspects of the invention. In particular, the processor can include highly parallelized computing units and high-performance graphics modules.

In connection with the invention, a volatile memory in the form of a working memory (random access memory, RAM), or a permanent memory such as a hard drive or a data carrier or, for example, a replaceable memory module can be understood. However, the storage module can also be a cloud-based storage solution.

The test agent 220 of the test agent module 200 creates a plurality of test cases Tᵢ for one or more driving tasks using a software application. The particular driving task is formulated prior to starting the simulation, for example, by an expert such as an engineer. However, a list of driving tasks can be generated by a software application. This list can then be successively edited by the system 100 according to the invention. An exemplary driving task is a lane change on a highway.

The test strategy 230 selects and designs the test cases Tᵢ and specifies how the test agent 220 creates the test cases Tᵢ. Various computational methods and algorithms, in particular algorithms of artificial intelligence, can be provided for establishing the test strategy 230. Thus, algorithms and calculation methods such as mean values, minimum and maximum values, lookup tables, expected value models, linear regression methods, Gaussian processes, fast Fourier transforms, integral and differential calculations, Markov method, probability methods, such as Monte Carlo methods, temporal difference learning, but also extended Kalman filters, radial basis functions, data fields, convergent neural networks, deep neural networks, and/or recurrent neural networks, which allow the strategy to be adapted through iteration procedures.

The required information for the creation of the test cases Tᵢ is taken by the test agent 220 from the calibration parameter database 320, the scenario database 330 and the evaluation database 340. In the context of the invention, it can be provided that further databases also are used. The created test cases Tᵢ are stored in the test database 300.

“Database” means both a storage algorithm and the also hardware in the form of a storage unit. In particular, the databases 300, 320, 330, 340 can be configured as part of a cloud computing infrastructure.

Data in connection with the invention should be understood as raw data as well as data already prepared from measurement results from sensors as well as from other data sources.

The creation of the test cases Tᵢ is based on parameterized scenarios, which are also referred to as logical scenarios. A parameterized scenario is referred to in the context of the invention as a scenario that is written in a machine-readable code. A parameterized scenario SZpᵢ is defined by various parameters P₁, P₂, . . . , Pₙ from a quantity of possible parameters Pᵢ and associated parameter values PV₁, PV₂, . . . , PVₙ from a quantity of possible parameter values PVᵢ. Parameter values PVᵢ define the range of values of a parameter Pᵢ. For example, a parameter Pᵢ sets a physical variable, a chemical variable, a torque, a rotary speed, a voltage, a current strength, an acceleration, a speed a braking value, a direction, an angle, a radius, a location, a number, a movable object such as a motor vehicle, a person or a cyclist, a stationary object such as a building or a tree, a road configuration such as a highway, a road sign, a traffic light, a tunnel, a roundabout, a turn-off lane, a traffic volume, a topographical structure such as an incline, a time, a temperature, a precipitation value, a weather condition and/or a time of year. Parameters Pᵢ thus denote characteristics and features of a scenario in the context of the invention. An example of a parameter Pᵢ is the speed of an ego vehicle, and a range of values of the associated parameter value PVᵢ can include the range of 100 km/h to 180 km/h for a scenario SZpᵢ. For another scenario SZpₖ, the range of values of the parameter value PVᵢ can range from 40 km/h to 70 km/h.

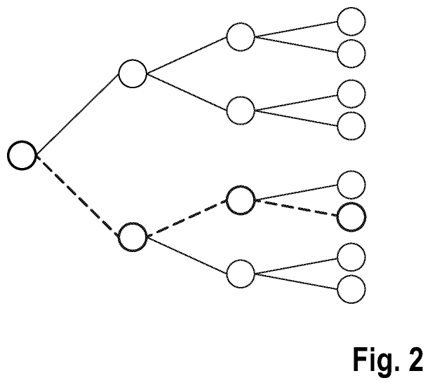

A parametrized scenario SZp comprises a time sequence of time intervals Δt₁, Δt₂, . . . , Δtₙ, in each of which different scenes and events take place. A parametrized scenario SZp starts with a start scene and then evolves through events that occur, resulting in new subsequent scenes over time. The start scene is thus amended by one or more events. An event can be a response actively triggered by a road user, such as an acceleration, as well as an event that recurs cyclically, for example, the switching operations of a traffic light. The start scene and the individual subsequent scenes thus each comprise only a small time interval Δt and/or a snapshot, while a parameterized scenario comprises SZp a longer period of time. In a graph representation of a scenario SZp, the events can be represented as edges and the individual scenes can be represented as nodes of a graph, as illustrated in FIG. 2

In the context of the present invention, a distinction is made between a parameterized scenario SZp and a specific scenario SZc. In the context of this invention, a scenario SZp is defined in which both the parameters Pᵢ and the associated parameter values PVᵢ are not all defined. A specific scenario SZc is defined as a scenario SZ in which the scenario parameters Pcᵢ and the associated scenario parameter values PVcᵢ and/or value ranges of the scenario parameter values PVcᵢ are set. In both scenarios, both the parameterized scenario SZp and the specific scenario SZc, are scenarios that are written in particular in a machine-readable code.

Various sources can be used to create parameterized scenarios SZpᵢ, such as requirement specifications, expert knowledge, and/or measurements in public traffic or on test sites using sensors. The sensors used can be configured as radar systems, LIDAR systems for optical distance and speed measurement, 2D/3D image recording cameras in the visible, IR and/or UV range, and/or GPS systems. Furthermore, accelerometers, speed sensors, capacitive sensors, inductive sensors, voltage sensors, torque sensors, precipitation sensors, and/or temperature sensors, etc. can be used. Thus, a software application can derive a corresponding parameterized scenario SZpᵢ from recorded data at a particular geographic location. In particular, the software application uses artificial intelligence algorithms to identify the parameterized scenarios SZpᵢ. The artificial intelligence algorithms can be encoders and decoders with neural networks.

A neural network consists of neurons arranged in multiple layers and interconnected to one another differently. A neuron is able to receive information at its input from outside or from another neuron, evaluate the information in a particular manner, and pass it on in altered form at the neuron output to another neuron, or output it as a final result. Hidden neurons are located between the input neurons and the output neurons. Depending on the type of network, multiple layers of hidden neurons can be present. They provide for the forwarding and processing of the information. Output neurons finally deliver a result and issue it to the outside world. Neural networks can be trained through unsupervised or supervised learning.

The different arrangement and linking of the neurons result in different types of neural networks, in particular a feedforward neural network (FNN), a recurrent neural network (RNN) or a convolutional neural network (CNN). A convolutional neural network has multiple fold layers and is very well suited to machine learning and uses in the field of pattern recognition and image recognition applications. Because a large proportion of the data captured by the sensors is present as images, particularly convolutional neural networks (CNN) are used.

In the context of the invention, the test agent 220 creates, from the set of possible parameterized scenarios SZpᵢ, those test cases Tᵢ that are of interest for the calibration and validation of ADAS/ADS. For this purpose, the test agent 220 selects suitable parameterized scenarios SZpᵢ and scenario parameters Pcᵢ from the scenario database 330 as well as calibration parameters Pcalᵢ from the calibration parameter database 320. These relevant test cases Tᵢ created by the test agent 220 cover the relevant traffic situations set out in the operational design domain (ODD) that must be managed by driving assistance systems and automated driving functions. A test case Tᵢ is thus a relevant specific scenario SZc defined through the specification of scenario parameters Pcᵢ and further calibration parameters Pcalᵢ.

The test strategy 230 of the test agent 220 decides on the configuration of the test cases Tᵢ by selecting suitable parameterized scenarios Szpᵢ and scenario parameters Pcᵢ as well as further calibration parameters Pcalᵢ. The test strategy 230 used is specified by way of the purpose of the simulation, i.e., which knowledge about the behavior of an ADAS/ADS and/or a specific driving function is to be obtained by a simulation when the specified driving task is performed. For example, for the virtual validation of an ADAS/ADS with a constant dataset of calibration parameters Pcalᵢ, different parameterized scenarios Szpᵢ and scenario parameter combinations can be created using a combinatorial method. Furthermore, an iterative strategy can be implemented based on mathematical optimizers to adapt the calibration parameters Pcalᵢ for a smaller set of different parameterized scenarios Szpᵢ.

The test agent 220 stores the test cases Tᵢ determined in this manner in the test database 300. The data for a test case Tᵢ can comprise a test identification number (test ID), a user name, a creation time, and the designation for the selected parameterized scenario Szpᵢ. Furthermore, the scenario parameters Pcᵢ that transform the parameterized scenario Szpᵢ into a specific scenario Szcᵢ are saved. Furthermore, calibration parameters Pcalᵢ and other data such as performance indicators (KPIs) can be stored regarding the evaluation of the performance of the respective driving assistance function in the simulation as well as evaluation indicators for the evaluation of the simulation performed. Furthermore, information regarding the status of the simulation such as “performed or not performed” can be associated with a test case Tᵢ. Additionally, further text messages, video sequences and/or audio sequences, etc. with further information can be stored. Overall, all the relevant information relating to a test case Tᵢ can thus be stored in the test database 300.

To perform a simulation of the test cases Tᵢ created, the test agent 220 passes a test case Tᵢ or multiple test cases Tᵢ on to the simulation module 400. In addition, the simulation module 400 can retrieve information regarding the calibration parameters Pcalᵢ from the calibration parameter database 320, as well as information about the parameterized scenarios SZp, and scenario parameters Pcᵢ, such as machine-readable scripts from the scenario database 330, to perform the simulation. The simulation module 400 comprises various sub-modules 410, 420, 430 that are configured to simulate specific characteristics of the test cases Tᵢ for the driving task being tested and that can interact with each other. They are configured as interchangeable sub-modules and have the task of simulating individual aspects of a respective test case Tᵢ or a plurality of test cases Tᵢ. A first sub-module 410 can be configured as an ambient model module that relates to the environment and maps various environments of a motor vehicle 10. A second sub-module 420 can be configured as a driver model module that relates to the driving mode and/or driving style of a driver, such as dynamic or defensive. A third sub-module 430 can be configured as a vehicle model module that comprises various models of a motor vehicle, for example, regarding the different configuration of the powertrain, drive dynamics, and other sub-functions. The sub-modules 410, 420, 430 implement the description of the respective test case Tᵢ for a specific situation and/or configuration and provide the necessary input data for simulating a driving assistance function in a driving function module 440.

The simulation module 400 and/or the various sub-modules 410, 420, 430 are connected to one or more databases 480 in which sensor signals from sensors 470 and other data are stored. The sensor signals are measurement data of characteristics and features of a motor vehicle 10 and of objects and events in the vicinity of the motor vehicle 10 that have been recorded during driving along a travel path during a defined time window Δti and/or a defined travel path portion Δxi. The objects in the traffic environment of the motor vehicle 10 can be other road users, such as motor vehicles, pedestrians, cyclists, and the events can comprise an acceleration operation, a lane change, or a change-over of a traffic light. The sensors 470 can be configured as radar systems, LIDAR systems for optical distance and speed measurement, 2D/3D image recording cameras in the visible, IR and/or UV range, and/or GPS systems. Furthermore, accelerometers, speed sensors, capacitive sensors, inductive sensors, voltage sensors, torque sensors, precipitation sensors, and/or temperature sensors, etc. can be provided.

Further historical data can also be stored in the database 480 in the form of images, graphics, time series, characteristic values, etc. For example, target variables and target values that define a safety standard for the simulation can be stored in the database 480. The database 480 can also be integrated into a cloud computing infrastructure.

Furthermore, additional data sources or databases can be used, such as databases that contain data regarding the road network with road specifications, such as lanes and bridges, road infrastructure such as the road surface, edge construction, road route, etc., and are provided by authorities.

Data on traffic figures, such as real hourly traffic volumes at a particular traffic location, are of interest for certain scenarios types, such as a traffic jam. Aerial photographs are another source of data, for example, from Google Maps. Mapillary can also be used for road images. Mapillary collects user-generated road images with geo-tags recorded by dashcams and smartphones. These images are available under an open source license.

Weather conditions can also define a scenario type, and hence weather data is another data source. Weather data comprises historical weather measurements and future weather forecasts.

The calculation and storage of the geographic coordinates of the detected objects is preferably carried out in the EPSG 25832-coordinate system (Universal Transverse Mercator (UTM) zone 32N). This system is used by authorities in Germany. The lateral and longitudinal positions are represented in meters. Furthermore, global reference systems such as the “world geodetic system 1984 (WGS 84)”, which is also used in GPS receivers (global positioning system), can be used. For example, the entire map content can be imported from Germany.

The test cases Tᵢ selected by the test agent are integrated into the various sub-modules 410, 420, 430. Input signals, such as sensor data, vehicle health information, and driver inputs from the sub-modules 410, 420, 430, are provided to perform a simulation of the selected test cases Tᵢ. For this purpose, the sub-modules 410, 420, 430 use simulation algorithms such as X-in-the-loop (XiL). In particular, the modeling of the sensors 470 is of particular significance because inaccuracies and measurement errors in the sensor signals from the sensors 470 must be taken into account in the virtual calibration and validation. If a selected test case Tᵢ and/or a plurality of test cases Tᵢ cannot cover a defined driving task, further data is provided via the sub-modules 410, 420, 430 to map and simulate the entirety of a driving event.

The simulation module 400 performs a simulation of the test cases Tᵢ for a set driving task and passes the simulation results 450 to the evaluation module 500.

The evaluation module 500 evaluates the simulation results 450 with regard to the performance and functional capability of one or more functions or the overall performance of a driver assistance system (ADAS) or an automated driving system (ADS), in particular in the form of performance indicators (KPIs). In addition, the quality of the simulation procedure carried out is evaluated, in particular in the form of simulation quality criteria (SQCs). From these evaluations, the evaluation module 500 produces evaluation results 550.

KPIs are used to describe the performance of an ADAS/ADS to be tested, and different KPIs are established for different evaluation categories, such as comfort, safety, naturalness of travel and efficiency. Additionally, further KPIs can be implemented to verify the correct functionality of the ADAS/ADS being tested. An example of a KPI is the evaluation of a minimum distance from another vehicle or a mean acceleration in a deceleration scenario.

In addition to the KPls, SQCs are used to evaluate the quality of the simulation. For example, other road users can be represented by modeled simulation representatives that make different decisions depending on the reactions of the ADAS/ADS being tested. For this reason, an evaluation must be conducted to verify whether the simulated scenario matches the scenario description of the test case Tᵢ. For this purpose, metrics are defined for the SQCs that provide feedback on the correct execution of a scenario simulation. Thus, the manner of performing an overtaking maneuver can be evaluated by means of an SQC, for example, with regard to whether a collision could be avoided. The KPIs and SQCs can be represented by numeric values and also by Boolean values.

Both direct and indirect evaluation metrics can be used for the KPIs and SQCs. Direct evaluation metrics contain data directly from simulated measurement data. Indirect evaluation metrics use scenario parameters as a data source. An example of the application of indirect evaluation metrics is the implementation of simulation models that quantify and evaluate a subjective perception of a driver during the performance of a driving assistance function of an ADAS/ADS. Based on the KPIs and SQCs, the results of a simulated test case Tᵢ can thus be represented by numerical values or Boolean values.

The evaluation results 550 in the form of performance indicators (KPIs) and simulation quality criteria (SQCs) are passed to the test agent module 200. The test agent 220 can provide the calibration parameters Pcalᵢ in the calibration parameter database 320, the parameterized scenarios Szpᵢ and the scenario parameters Pcᵢ in the scenario database 330, and the evaluation results 550 in the evaluation database 340 with labels such as weights or for identifying particular characteristics to create new test cases Tₖ for the set driving task. In particular, the test strategy 230 can be adapted using the data labeled by the evaluation results 550 in the calibration parameter database 320, the scenario database 330, and the evaluation database 340. The test cases Tₖ are in turn deposited in the test database 300 and can be used for a new simulation cycle in the simulation module 400 and a subsequent evaluation in the evaluation module 500.

To adapt the test cases Tₖ for a new simulation run, the calibration parameters, Pcalᵢ, are changed while the scenario parameters remain the Pcᵢ same. The calibration parameters Pcalᵢ may be changed on the basis of the performance indicators (KPIs) created by the function evaluation module 510. By iterating the calibration parameters Pcalᵢ for new test cases Tₖ, an optimal set of calibration parameters Pcalᵢ can be determined.

Furthermore, given constant calibration parameters Pcalᵢ, the test agent 220 can vary the scenario parameters Pcᵢ to iteratively determine the critical specific scenarios Szcᵢ.

The combination of the simulation module 400 and the evaluation module 500 forms the basis for processing test cases Tᵢ in the context of the virtual calibration and validation. Test cases Tᵢ created by the test agent 220 are simulated in the simulation module 400. The simulation module has access to the calibration parameter database 320 and the scenario database 330 to obtain the required information. After successful simulation, the simulation results 450 are transferred to the evaluation module 500. The assessment module 500 has access to the evaluation database 340 and the scenario database 330 to deposit the evaluation results 550 of the simulation results 450 therein. Both the simulation module 400 and the evaluation module 500 contain interchangeable sub-modules, thereby enabling an adaptation to different functions and application cases, as well as separate development of the sub-modules.

After completion of a first simulation cycle with first test cases Tᵢ, second test cases Tₖ are created by the test agent 220 using the test strategy 230 adapted to the simulation results 450 and the calculation results of the first simulation run. A new simulation run is begun with these second test cases Tₖ. The evaluation results 550 are used to decide whether the second test cases Tₖ satisfy a particular evaluation criterion or whether a further adaptation of the test strategy 230 is required to perform a further simulation cycle. If the evaluation results 550 reveal that the simulation result 450 converges, the test cases Tₖ of the last simulation cycle are passed on to the output module 700.

On the basis of the evaluation results 550 generated in the form of KPIs and SQCs by the evaluation module 500, an optimal dataset of calibration parameters Pcalᵢ for the driver assistance system (ADAS) and/or the automated driving system (ADS) and/or the driving function for performing the set driving task can then be determined for the test cases Tₖ of the last simulation cycle. This dataset of calibration parameters Pcalᵢ defines the behavior of the driver assistance system (ADAS) and/or the automated driving system (ADS) and/or the driving function for the set driving task and can then be output as output results 750 from the output module 700. In addition, the output results 750 contain information about the simulation performed. The quality of the output results 750 thereby depends on the quality of the scenario description and the type of simulation as well as the definition of the evaluation metrics.

The simulation module 400 comprises different sub-modules 410, 420, 430. Thus, a simple adaptation to different ADAS and ADS can be made by replacing sub-modules. Furthermore, the sub-modules 410, 420, 430 can be developed and validated independently, resulting in higher quality of the overall process. The simulation module 400 can therefore be adapted to different application cases by means of the interchangeable sub-modules 410, 420, 430. Different driving tasks can be implemented simply by changing the test strategy 230 of the test agent 220.

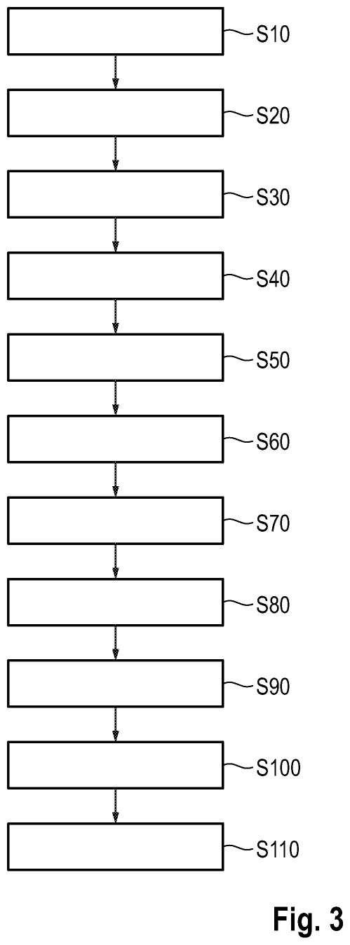

In FIG. 3, the method steps for calibrating and validating a driver assistance system (ADAS) and/or an automated driving system (ADS) for a set driving task are shown in at least one scenario SZᵢ.

In a step S10, first test cases are created Tᵢ by a test agent 220 by selecting parameterized scenarios SZpᵢ and scenario parameters Pcᵢ as well as calibration parameters Pcalᵢ using a test strategy 230 for the driving task.

In a step S20, the selected first test cases Tᵢ are passed on to a simulation module 400.

In a step S30, a simulation is performed from the simulation module 400 to determine simulation results 450.

In a step S40, the simulation results 450 are passed on to an evaluation module 500.

In a step S50, an evaluation of the simulation results 450 is performed by the evaluation module 500 for determining evaluation results 550.

In a step S60, the test strategy 230 is adapted to the simulation results 450 and the evaluation results 550.

In a step S70, second test cases Tₖ are created by the test agent 220 using the adapted test strategy 230.

In a step S80, a new simulation cycle for the second test cases Tₖ is started.

In a step S90, the adaptation of the test strategy 230 to perform a further simulation cycle is repeated if a particular evaluation criterion is not met.

In a step S100, the test cases Tₖ of the last simulation cycle are passed on to an output module 700 if a particular evaluation criterion is met.

In a step S110, output results 750 from the test cases Tₖ are generated and output by the output module 200 for calibration and validation purposes, particularly in the form of calibration parameters Pcalᵢ for the driver assistance system (ADAS) and/or the automated driving system (ADS) and/or the driving function for performing the set driving task.

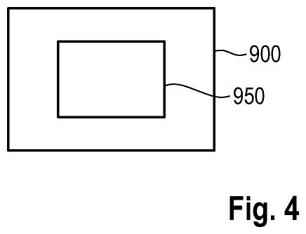

FIG. 4 schematically represents a computer program product 900 comprising an executable program code 950 that is configured to perform the method according to the first aspect of the present invention.

By means of the invention, an optimal set of calibration parameters for virtual calibration and validation of ADAS/ADS can be generated by the use of modular-structured modules. The modules can be developed and tested independently of each other, thereby increasing the quality of the overall process. By integrating and linking the necessary modules, the system 100 according to the invention can purposefully and efficiently perform a virtual calibration and validation of an ADAS/ADS. In this way, resources can be conserved, since actual departures from test routes both with standard traffic situations as well as with specific corner cases can be reduced.

### REFERENCE NUMBERS

10 Motor vehicle
100 System
200 Test agent module
220 Test agent
230 Test strategy
300 Test database
320 Calibration parameter database
330 Scenario database
340 Evaluation database
400 Simulation module
410 Environment model module
420 Driver model module
430 Vehicle model module
440 Driving function module
450 Simulation results
470 Sensors
480 Database
500 Evaluation module
510 Function evaluation module
520 Simulation evaluation module
550 Evaluation results
700 Output module
750 Output data
900 Computer program product
950 Program code

1. A method for calibrating and validating at least one of a driver assistance system (ADAS), an automated driving system (ADS) and a driving function for a set driving task in at least one scenario (SZᵢ), wherein a scenario (SZᵢ) represents a traffic event in a temporal sequence and is defined by a selection of parameters (P₁, P₂, . . . , Pₙ) and associated parameter values (PV₁, PV₂, . . . , PVₙ), and wherein in a parameterized scenario (SZpᵢ) the parameters (P₁, P₂, . . . , Pₙ) and associated parameter values (PV₁, PV₂, . . . , PVₙ) are freely selectable, and for a specific scenario (SZcᵢ) the scenario parameters (Pc₁, Pc₂, . . . , P_{cn}) and associated scenario parameter values (PVc₁, PVc₂, . . . , PVcₙ) are set, the method comprising:
using a test agent (220) of a test agent module (220) for creating (S10) first test cases (Tᵢ) by selecting parameterized scenarios (SZpᵢ), scenario parameters (Pcᵢ) and calibration parameters (Pcalᵢ) using a test strategy (230) for the driving task;
passing on (S20) the first test cases (Tᵢ) to a simulation module (400);
performing (S30) a simulation by the simulation module (400) to determine simulation results (450);
passing on (S40) the simulation results (450) to an evaluation module (500);
performing (S50) an evaluation of the simulation results (450) by the evaluation module (500) for determining evaluation results (550);
adapting (S60) the test strategy (230) to the simulation results (450) and the evaluation results (550);
using the test agent (220) for creating (S70) second test cases (Tₖ) using the adapted test strategy (230);
starting (S80) a new simulation cycle for the second test cases (Tₖ);
repeating (S90) the adaptation of the test strategy (230) for performing a further simulation cycle if a particular evaluation criterion is not met; or
passing on (S100) the test cases (Tₖ) of the last simulation cycle to an output module (700) if a particular evaluation criterion is met;
generating and outputting (S110) output results (750) from the test cases (Tₖ) for calibration and validation purposes by the output module (200), the output results including the calibration parameters (Pcalᵢ) for at least one of the driver assistance system (ADAS), the automated driving system (ADS) and the driving function for performing the set driving task.

2. The method of claim 1, wherein the simulation module (400) comprises interchangeable sub-modules (410, 420, 430) that include a first sub-module (410) configured as an environmental model module, a second sub-module (420) configured as a driver model module, and a third sub-module (430) configured as a vehicle model module.

3. The method of claim 2, wherein the simulation module (400) and the sub-modules (410, 420, 430) are connected to at least one of sensors (470) and a database (450) to obtain further information for creating simulation models, wherein the simulation models are passed on to a driving function module (440) to perform the simulation of a driving assistance function.

4. The method of claim 1, wherein the assessment module (500) comprises a driving function evaluation module (520) for determining performance and safety of a driving function using performance indicators (KPIs) and a simulation evaluation module (520) for determining the quality of the simulation using simulation quality criteria (SQCs), and wherein the evaluation results (550) comprise the performance indicators (KPIs) and the simulation quality criteria (SC).

5. The method of claim 1, wherein the test cases (Tᵢ) are stored in a test database (300), the calibration parameters (Pcalᵢ) are stored in a calibration parameter database (320), the parameterized scenarios (SZpᵢ) and the scenario parameters (Pcᵢ) are stored in a scenario database (330), and the evaluation results (550) are stored in an evaluation database (340).

6. The method of claim 1, wherein the test strategy (230) and the test agent (220) use at least one software application having calculation methods and algorithms of artificial intelligence.

7. The method of claim 6, wherein the algorithms and calculation methods are configured as at least one of mean values, minimum and maximum values, lookup tables, expected value models, linear regression methods, Gaussian processes, fast Fourier transforms, integral and differential calculations, Markov methods, probability methods, such as Monte Carlo methods, temporal difference learning, extended Kalman filters, radial basis functions, data fields, convergent neural networks, deep neural networks, and recurrent neural networks.

8. The method of claim 1, wherein the parameter (Pᵢ) comprises at least one of a physical variable, a chemical variable, a torque, a speed, a voltage, a current strength, an acceleration, a speed, a braking value, a direction, an angle, a radius, a location, a number, a movable object, a stationary object, a road configuration, a road sign, a traffic volume, a topographical structure, a time, a temperature, a precipitation value, a weather condition and a time of year.

9. The method of claim 1, wherein the sensors (470) are configured as at least one of a radar system, LI DAR optical distance and speed measurement system, image recording 2D/3D cameras, GPS systems, accelerometers, speed sensors, capacitive sensors, inductive sensors, voltage sensors, torque sensors, precipitation sensors, and temperature sensors.

10. A system (100) for calibrating and validating at least one of a driver assistance system (ADAS), an automated driving system (ADS) and a driving function for a set driving task in at least one scenario (SZᵢ) representing a traffic event in a temporal sequence and is defined by a selection of parameters (P₁, P₂, . . . , Pₙ) and associated parameter values (PV₁, PV₂, . . . , PVₙ), and wherein, in a parameterized scenario (SZpᵢ), the parameters (P₁, P₂, . . . , Pₙ) and associated parameter values (PV₁, PV₂, . . . , PVₙ) are freely selectable, and in a specific scenario (SZcᵢ) the parameters (Pc₁, Pc₂, . . . , P_{cn}) and associated parameter values (PVc₁, PV_{c2}, . . . , PVcₙ) are defined, the system comprising: a test module (200) having a test agent (220) and a test strategy (230), a simulation module (400), an evaluation module (500) and an output module (700), wherein: the test agent (220) is configured to generate first test cases (Tᵢ) by selecting parameterized scenarios (SZpᵢ), scenario parameters (Pcᵢ) and calibration parameters (Pcalᵢ) using the test strategy (230) for the driving task and passing on the selected first test cases (Tᵢ) to the simulation module (400); the simulation module (400) is configured to perform a simulation to determine simulation results (450) and to pass the simulation results (450) on to the evaluation module (500); the evaluation module (50) is configured to perform an evaluation of the simulation results (450) to determine evaluation results (550); the test module (200) is configured to adapt the test strategy (230) to the simulation results (450) and the evaluation results (550), to create second test cases (Tₖ) from the test agent (220) using the adapted test strategy (230) and begin a new simulation cycle for the second test cases (Tₖ), and to repeat the adaptation of the test strategy (230) for performing a further simulation cycle, if a particular evaluation criterion is not met, or pass the test cases (Tₖ) of the at least last simulation cycle on to the output module (700), if a particular evaluation criterion is met; and the output module (700) is configured to generate and output results (750) outputted from the test cases (Tₖ) of the at least last simulation cycle for calibration and validation purposes in the form of calibration parameters (Pcalᵢ) for at least one of the driver assistance system (ADAS), the automated driving system (ADS) and the driving function for performing the determined driving task.

11. The system (100) of claim 10, wherein the simulation module (400) comprises interchangeable sub-modules (410, 420, 430) that include: a first sub-module (410) configured as an environmental model module, a second sub-module (420) configured as a driver model module, and a third sub-module (430) configured as a vehicle model module.

12. The system (100) of claim 10, wherein at least one of the simulation module (400) and the sub-modules (410, 420, 430) are connected to sensors (470) and/or a database (450) to obtain further information for creating simulation models, wherein the simulation models are passed on to a driving function module (440) to perform the simulation of a driving assistance function.

13. The system (100) of claim 10, wherein the evaluation module (500) comprises a driving function evaluation module (520) for determining performance and safety of a driving function using performance indicators (KPIs) and a simulation evaluation module (520) for determining quality of the simulation using simulation quality criteria (SQCs), and wherein the evaluation results (550) comprise the performance indicators (KPIs) and the simulation quality criteria (SQCs).

14. The system (100) of claim 10, wherein the test cases (Tᵢ) are stored in a test database (300), the calibration parameters (Pcalᵢ) are stored in a calibration parameter database (320), the parameterized scenarios (SZpᵢ) and the scenario parameters (Pcᵢ) are stored in a scenario database (330) and the evaluation results (550) are stored in an evaluation database (340); and wherein at least one of the textual strategy (230) and the test agent (220) uses at least one software application having calculation methods or algorithms of artificial intelligence.

15. A computer program product (900) comprising an executable program code (950) that is configured to execute the method of claim 1.
